(19) United States
(12) Patent Application Publication
(10) Pub. No.: US 2002/0147665 A1
(43) Pub. Date: Oct. 10, 2002

(54) System, methods, and apparatus for facilitating providing a quote

(76) Inventors: Jeffry Alan Tillery, Radiant, VA (US); Peter Thomas Durand, Charlottesville, VA (US); David John George, Charlottesville, VA (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,439

(22) Filed: Apr. 5, 2001

(51) Int. Cl. G06F 17/60

(52) U.S. Cl. 705/28; 705/11

(57) ABSTRACT

A method for facilitating providing a customer with a quote for a manufactured product includes receiving data relating to a customer desired product including at least one of a feature and a function, and receiving at least one indication of importance for at least one of the feature and the function. The method further includes accessing at least one database containing at least one of inventory control data, component data, and image data, and generating a first quote based on the received data, the received indication, and data stored in the accessed database.

### BACKGROUND OF THE INVENTION

This invention relates generally to engineered system solutions, and more particularly, to providing quotes of engineered system solutions.

When a customer requests a system level solution from a manufacturer, typically the manufacturer invests a considerable expense in generating a quote. The manufacturer manually prepares a bill of materials (BOM) and calculates a cost of the material to generate a price quote. Accordingly, the customer typically waits up to three weeks to receive a requested quote. Additionally, sometimes the customer decides not to purchase the quoted solution, and the manufacturer does not recoup the resources invested in providing the quote. Furthermore, some customers will change their desired features and request a second quote seeking a less expensive solution. Accordingly, the manufacturer invests additional resources to generate and provide a second quote.

### SUMMARY OF THE INVENTION

In one embodiment, a method for facilitating providing a customer with a quote for a manufactured product includes receiving data relating to a customer desired product including at least one of a feature and a function, and receiving at least one indication of importance for at least one of the feature and the function. The method further includes accessing at least one database containing at least one of inventory control data, component data, and image data, and generating a first quote based on the received data, the received indication, and data stored in the accessed database.

In another embodiment, a method for facilitating providing a customer with a quote for a computer numerically controlled (CNC) fabricated product includes receiving data relating to a customer desired product including at least one of a feature and a function, and receiving at least one indication of importance for at least one of a product price, a product size, and a product functionality. The method further includes accessing at least one database containing at least one of inventory control data, component data, and image data, generating a first quote based on the received data, the received indication, and the accessed database. The method further includes providing the customer with the generated first quote including a product price, a delivery date, a three dimensional image, and a short-term Z transform estimate, and prompting the customer to iterate a second quote.

In yet another embodiment, a system for facilitating providing a customer with a quote for a manufactured product includes at least one device, and a server connected to the device. The server receives data relating to a customer desired product including at least one of a feature and a function, and receives at least one indication of importance for at least one of the feature and the function. The server accesses at least one database containing at least one of inventory control data, component data, and image data, and generates a first quote based on the received data, the received indication, and data stored in the accessed database.

In a further embodiment, an apparatus includes at least one device and a server connected to the device via a network. The server receives data relating to a customer desired product including at least one of a feature and a function, and receives an indication of importance for at least one of a product price, a product size, and a product functionality. In addition, the server accesses at least one database containing at least one of inventory control data, component data, and image data, and generates a first quote based on the received data, the received indication, and data stored in the accessed database. The server further provides the first quote to the customer including a product price, a delivery date, a three dimensional image, and a short-term Z transform estimate, and prompts the customer to iterate a second quote.

### BRIEF DESCRIPTION OF THE DRAWINGS

FIG. 1 is a block diagram of web-based integrated customer request for quote (RFQ) response system in accordance with one embodiment of the present invention.

FIG. 2 is an expanded block diagram of an exemplary embodiment of a server architecture of a RFQ response system.

FIG. 3 is a process map for one embodiment of a web-based integrated customer RFQ response system.

### DETAILED DESCRIPTION

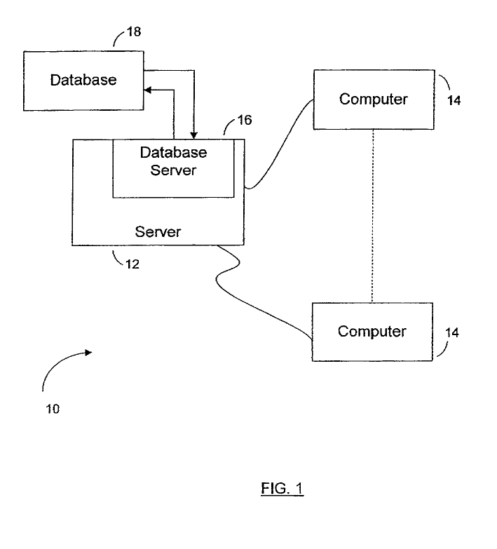

FIG. 1 is a block diagram of a web-based integrated customer request for quote (RFQ) response system 10 in accordance with one embodiment of the present invention. System 10 includes a server sub-system 12, sometimes referred to herein as a server and a web server, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including cable modems, high-speed Integrated Services Digital Network (ISDN) lines, and telephone connections including telephone modems and DSL connections (Digital Subscriber Line). Alternatively, devices 14 are any device capable of interconnecting to a network including a network-based phone or other network-based connectable equipment including a hand-held wireless device. Server 12 includes a database server 16 connected to a centralized database 18 including a computer readable medium containing inventory information, image files, and component information. In one embodiment, centralized database 18 is stored on database server 16 and can be accessed by potential users at one of user devices 14 by logging onto server sub-system 12 through one of user devices 14. In an alternative embodiment, centralized database 18 is stored remotely from server 12. In a further embodiment, a plurality of databases 18 are stored remotely from server 12, such as, for example an inventory control database, a component database, and an image database.

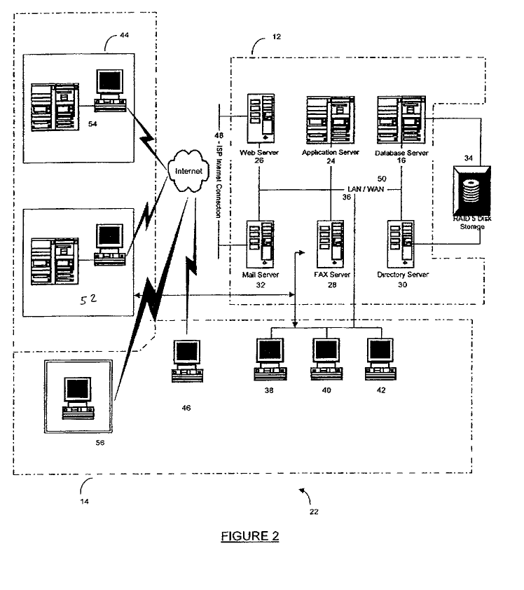

FIG. 2 is an expanded block diagram of an exemplary embodiment of a server architecture of a RFQ response system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser.

Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In an alternative embodiment, server sub-system 12 is configured to be communicatively coupled to various individuals or employees 44 and to third parties, e.g., users, 46 via an Internet Service Provider (ISP) Internet connection 48. The communication in the exemplary embodiment is illustrated as being performed via the Internet, however, any other WAN type communication can be utilized in other embodiments, i.e., the systems and processes are not limited to being practiced via the Internet. In addition, and rather than a WAN 50, local area network 36 could be used in place of WAN 50.

In an exemplary embodiment, any employee 44 or user 46 having a workstation 52 can access server sub-system 12. One of user devices 14 includes a workstation 54 located at a remote location. Workstations 52 and 54 are personal computers having a web browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

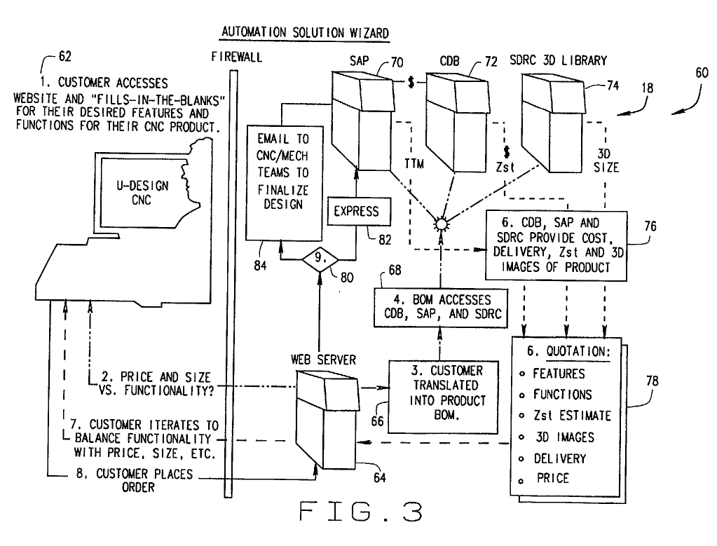

FIG. 3 is a process map 60 for one embodiment of a web-based integrated customer RFQ response system. A customer accesses 62 a manufacturer's web site and provides data regarding a desired computer numerically controlled (CNC) fabricated product. More particularly, the customer enters at least one desired feature and/or function for the CNC fabricated product. In one embodiment, the customer provides data regarding at least one of a desired product price, a desired product size, and a desired product functionality. In an exemplary embodiment, the customer indicates a balancing of the price, size, and functionality. For example, the customer is prompted to select a level of importance for each of price, size, and functionality. In one embodiment, the customer indicates one of extremely important, very important, important, and less important for each category of features and functions e.g., a price category, a size category, and a functionality category. In another embodiment, the customer selects a numerical value for each category. For example, the customer is prompted to enter a number between one and ten for each category, with ten indicating the most important and one indicating the least important. In an alternative embodiment, the customer is prompted to indicate the importance of categories other than price, size, and functionality, such as, for example, material, weight, and color.

A web server 64 receives the customer's data and indications of importance for the categories of desired features and/or functions and generates 66 a product bill of material (BOM). In one exemplary embodiment, web server 64 utilizes 68 a plurality of databases 18 including an inventory control database 70, a component database 72, and an image database 74 to generate 66 the BOM. In an exemplary embodiment, inventory control database 70 is a SAP database utilizing software commercially available from SAP America Inc., Newtown Square Pennsylvania. Image database 74 is a Structured Dynamic Research Corporation (SDRC) database utilizing software commercially available from SDRC, Milford, Ohio. In one embodiment, inventory control database 70, component database 72, and image database 74 are remote from web server 64. In another embodiment, inventory control database 70, component database 72, and image database 74 are contained within web server 64. In an exemplary embodiment, web server 64 is web server 26 (shown in FIG. 2). In an alternative embodiment, web server 64 is server 12 (shown in FIG. 1).

Additionally, web server 64 utilizes databases 18 to generate 76 a product price, a product delivery date, a product Z transform estimate, and at least one three-degree (3D) image of the product. The product delivery date is based on a time to market (TTM) calculation made by web server 64. The TTM includes a time to production (lead time) and a production time. In an exemplary embodiment, the Z transform estimate is a short-term Z transform (Zst) estimate. Web server 64 integrates 78 at least two of the price, the delivery date, the 3D image, the Zst estimate, the customer desired functions, and the customer desired features into a quote which is provided to the customer. The customer receives the quote and is prompted to place an order or to iterate the process by changing the level of importance of at least one category of features or functions.

In use a customer utilizes device 14 to access the manufacturer's website and is prompted to enter desired features and functions for a CNC manufactured product. In an exemplary embodiment, the customer utilizes a template including a plurality of blank data fields. The customer enters data in the blank fields and selects a submit button to transmit the data to server 12. As explained above, server 12 access a plurality of databases 18, utilizing databases 18 to generate 76 a product price, a product delivery date, a Z transform estimate, and at least one three-degree (3D) image of the product, which are integrated into a quote provided to the customer. If the customer is not satisfied with the provided quote, the customer can make changes to the data entered in the fields and request a second quote. Accordingly, the customer can continue to iterate the process until the customer obtains a satisfactory quote. More particularly, the customer can balance the customer's desired functionality with desired features facilitating the customer reaching a satisfactory price. Alternatively, the customer can balance the customers desired features with a desired price to reach a satisfactory functionality.

Each time the customer is provided a quote, the customer is prompted to accept that quote and place an order for the product. When web server 66 receives an order, web server 66 transmits the order to at least one of an express program 82 and a CNC team 84. Web server 66 compares the order to data stored in component database 72 and determines if the product can be fabricated utilizing stored components or if the product requires a component not stored in database 72. When web server 72 determines that component database 72 contains sufficient information to fully fabricate the product, web server 66 transmits the order to an express program that integrates components from component database 72 to generate a final design. When web server 66 determines that the product requires a component not stored in component database 72, web server 66 transmits the order to a CNC team 84 that designs the component not stored in database 72 and generates a final design. In an exemplary embodiment, whenever CNC team 84 designs a component, that component is automatically added to database 66 and an image file is automatically stored in image database 74. Accordingly, the number of components stored in database 72 is continually increasing. In one embodiment, the web based integrated customer RFQ system is fully automated. In another embodiment, the web based integrated RFQ system is less than fully automated and is programmed to seek human intervention under certain conditions.

While the invention has been described in terms of various specific embodiments, those skilled in the art will recognize that the invention can be practiced with modification within the spirit and scope of the claims.

1. a method for facilitating providing a customer with a quote for a manufactured product, said method comprising the steps of:
receiving data relating to a customer desired product including at least one of a feature and a function;
receiving at least one indication of importance for at least one of the feature and the function;
accessing at least one database containing at least one of inventory control data, component data, and image data; and
generating a first quote based on the received data, the received indication, and data stored in the accessed database.

2. A method according to claim 1further comprising the step of translating the received data into a product bill of materials (BOM).

3. A method according to claim 2 further comprising the step of utilizing the BOM in conjunction with the accessed database to generate at least one of a product price, a product delivery date, a product Z transform estimate, and a three dimensional (3D) image.

4. A method according to claim 3 further comprising the steps of:
providing at least one of the product price, the product delivery date, the product Z transform estimate, and the 3D image to the customer; and
prompting the customer to iterate a second quote.

5. A method according to claim 1further comprising the steps of:
providing the first quote to the customer; and
prompting the customer to iterate a second quote.

6. A method according to claim 4 wherein said step of prompting the customer further comprises the step of prompting the customer to enter a different indication of importance for at least one of a feature and a function.

7. A method according to claim 1 wherein said step of receiving at least one indication further comprises the step of receiving an indication of importance for at least one of a product price, a product size, and a product functionality.

8. A method according to claim 1 further comprising the step of providing the customer with the generated first quote including a product price, a delivery date, a three dimensional image, and a short-term Z transform estimate.

9. A method for facilitating providing a customer with a quote for a computer numerically controlled (CNC) fabricated product, said method comprising the steps of:
receiving data relating to a customer desired product including at least one of a feature and a function;
receiving at least one indication of importance for at least one of a product price, a product size, and a product functionality;
accessing at least one database containing at least one of inventory control data, component data, and image data;
generating a first quote based on the received data, the received indication, and the accessed database;
providing the customer with the generated first quote including a product price, a delivery date, a three dimensional image, and a short-term Z transform estimate; and
prompting the customer to iterate a second quote.

10. A system for facilitating providing a customer with a quote for a manufactured product, said system comprising:
at least one device; and
a server connected to said device and configured to:
receive data relating to a customer desired product including at least one of a feature and a function;
receive at least one indication of importance for at least one of the feature and the function;
access at least one database containing at least one of inventory control data, component data, and image data; and
generate a first quote based on the received data, the received indication, and data stored in the accessed database.

11. A system according to claim 10 wherein said server further configured to translate the received data into a product bill of materials (BOM).

12. A system according to claim 11 wherein said server further configured to utilize the BOM in conjunction with the data stored in the accessed database to generate at least one of a product price, a product delivery date, a product Z transform estimate, and a three dimensional (3D) image.

13. A system according to claim 12 wherein said server further configured to:
provide at least one of the product price, the product delivery date, the product Z transform estimate, and the 3D image to the customer; and
prompt the customer to iterate a second quote.

14. A system according to claim 11 wherein said server further configured to:
provide the first quote to the customer; and
prompt the customer to iterate a second quote.

15. A system according to claim 13 wherein said server further configured to prompt the customer to enter a different indication of importance for at least one of a feature and a function.

16. A system according to claim 11 wherein said server further configured to receive an indication of importance for at least one of a product price, a product size, and a product functionality.

17. A system according to Claim 11 wherein said server further configured to provide the customer with the generated first quote including a product price, a delivery date, a three dimensional image, and a short-term Z transform estimate.

18. A system according to claim 11 wherein said server connected to said device by a network.

19. A system according to claim 18 wherein said network comprises at least one of an intranet, a WAN, a LAN, and the Internet.

20. Apparatus comprising:
at least one device; and
a server connected to said device via a network and configured to:
receive data relating to a customer desired product including at least one of a feature and a function;
receive an indication of importance for at least one of a product price, a product size, and a product functionality;
access at least one database containing at least one of inventory control data, component data, and image data;
generate a first quote based on the received data, the received indication, and data stored in the accessed database;
provide the first quote to the customer including a product price, a delivery date, a three dimensional image, and a short-term Z transform estimate; and prompt the customer to iterate a second quote.
